(19) United States
(12) Patent Application Publication
(10) Pub. No.: US 2013/0167690 A1
(43) Pub. Date: Jul. 4, 2013

(54) Method for Marking a Tool

(71) Applicant: Da-Sen LIN, Taichung City (TW)

(72) Inventor: Da-Sen LIN, Taichung City (TW)

(21) Appl. No.: 13/339,065

(22) Filed: Dec. 28, 2011

(51) Int. Cl. B23P 17/00; B24C 1/00; B24B 1/00; C25D 5/02

(52) U.S. Cl. 76/114; 76/101.1; 76/119

(57) ABSTRACT

Disclosed is a method for marking a tool. The method includes the steps of providing a tool, executing heat treatment on the tool, providing a ground layer on the tool, printing the tool, and electroplating the tool. In the step of printing the tool, a paint layer is provided on the ground layer. The paint layer includes at least one identification unit. The identification unit includes at least one identification zone provided with paint, a background provided around the identification zone and clear of any paint, and a borderline provided around the background and provided with paint. In the step of electroplating the tool, a coat is provided on portions of the ground layer that are not covered by the identification zone and the borderline. There is sharp contrast of the coat against the paint layer.

### FIELD OF INVENTION

The present invention relates to a tool and, more particularly, to a method for marking a tool so that the tool bears a clear, durable and aesthetic mark.

### BACKGROUND OF INVENTION

To drive a fastener such as a threaded bolt and a nut, an open-ended wrench, a box-ended wrench, a monkey wrench or a socket wrench may be used. A socket wrench kit includes a handle and a set of sockets of various sizes. In operation, the handle is connected to a selected one of the sockets for driving a fastener of a certain size. Thus, a socket wrench kit can be used to drive fasteners of various sizes. A socket wrench kit is lighter and less expensive than a set of open-ended wrenches or box-ended wrenches.

It is important to mark the sockets of a socket wrench kit to indicate the sizes of the sockets. It is sometimes desirable to provide a pattern, logo or trademark on the sockets. There have been attempts to provide plastic collars of different colors on the sockets. The plastic collars could easily be blurred, damaged or detached from the sockets so that the sockets would be poorly marked or not marked at all.

Alternatively, indented marks may be made in the sockets by pressing. It however requires an expensive machine to execute the pressing. Moreover, the indented marks are unclear on the sockets. This problem will be even worse when the indented marks are filled with dirt and grease after some time of use.

A socket is often electroplated after it is pressed. The electroplating is useful in protecting the socket from rust. The electroplating is provided on the socket in and outside the indented mark. That is, the color of the socket in the indented mark is identical to the color of the socket outside the indented mark. The electroplating makes the indented marks more unclear.

There has been another attempt to provide manganese phosphate on a socket after the pressing. The manganese phosphate is useful in protecting the socket from rust. The manganese phosphate however makes the socket look black and blur the indented mark.

Therefore, the present invention is intended to obviate or at least alleviate the problems encountered in prior art.

### SUMMARY OF INVENTION

It is the primary objective of the present invention to provide a method for marking a tool.

To achieve the foregoing objective, the method includes the steps of providing a tool, executing heat treatment on the tool, providing a ground layer on the tool, printing the tool, and electroplating the tool. In the step of printing the tool, a paint layer is provided on the ground layer. The paint layer includes at least one identification unit. The identification unit includes at least one identification zone provided with paint, a background provided around the identification zone and clear of any paint, and a borderline provided around the background and provided with paint. In the step of electroplating the tool, a coat is provided on portions of the ground layer that are not covered by the identification zone and the borderline. There is sharp contrast of the coat against the paint layer.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a flow chart of a method for marking a tool in accordance with the first embodiment of the present invention;

FIG. 2 is a perspective view of a tool to be marked by the method shown in FIG. 1;

FIG. 3 is an enlarged, partial, cross-sectional view of the tool shown in FIG. 2;

FIG. 4 is a perspective view of the tool after the step of printing of the method shown in FIG. 1;

FIG. 5 is an enlarged, partial, cross-sectional view of the tool shown in FIG. 4;

FIG. 6 is a perspective view of the tool after the step of electroplating of the method shown in FIG. 1;

FIG. 7 is an enlarged, partial, cross-sectional view of the tool shown in FIG. 6;

FIG. 8 is a perspective view of the tool after the step of printing of a method for marking a tool in accordance with the second embodiment of the present invention;

FIG. 9 is an enlarged, partial, cross-sectional view of the tool shown in FIG. 8;

FIG. 10 is a perspective view of the tool after the step of electroplating of the method shown in FIG. 8; and

FIG. 11 is an enlarged, partial, cross-sectional view of the tool shown in FIG. 10.

### DETAILED DESCRIPTION OF EMBODIMENTS

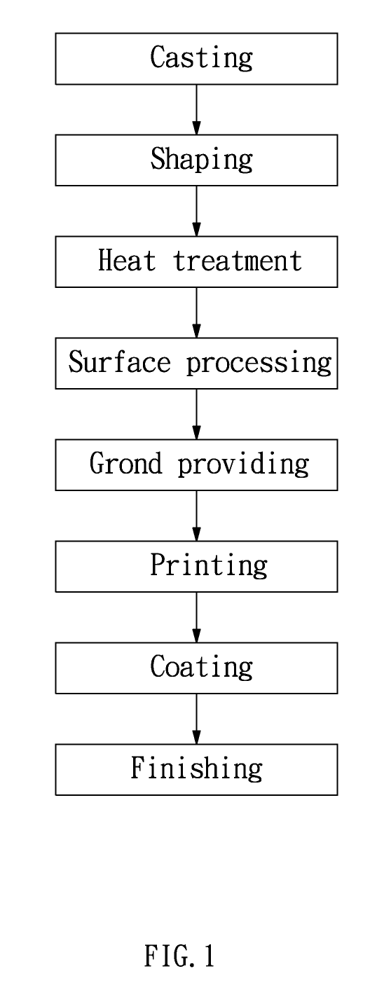

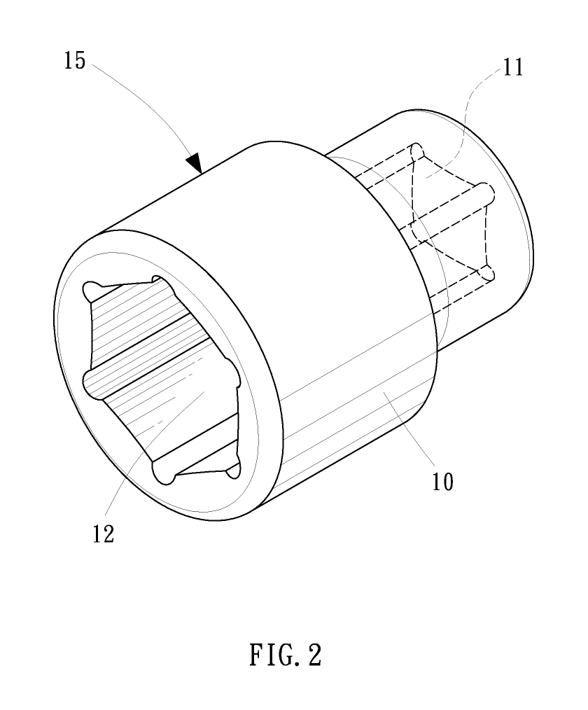

Referring to FIG. 1, there is shown a method for marking a tool 10 as shown in FIG. 2 according to a first embodiment of the present invention. The tool 10 may be a socket for example. The method includes the steps of casting, shaping, heat treatment, surface processing, ground providing, printing, coating and finishing.

In the step of casting, a block of metal is cast into an as-cast (or “prototype”).

In the step of shaping, the as-cast of the socket 10 is shaped in compliance with a bit to be engaged with and driven by the socket 10. The step of shaping may include the steps of lathing, milling and drilling for example. Thus, the socket 10 is made with two sections 11 and 12 axially. The first section 11 of the socket 10 includes a square cavity axially defined therein for receiving a square tongue of a handle. The second section 11 of the socket 10 includes a hexagonal cavity axially defined therein for receiving a nut or a head of a screw. The socket 10 includes an external face and an internal face. The external and internal faces of the socket 10 together are referred to as the surface 15 of the socket 10.

Then, the socket 10 is subjected to the step of heat treatment to increase the hardness thereof. Thus, the socket 10 is less vulnerable to wearing.

Then, the socket 10 is subjected to the step of surface processing. The step of surface processing may include the steps of grinding and shot blast. The step of grinding is used to clear the socket 10 of burs (or “deckle edges”). The step of shot blast is used to make the surface 15 rough so that dye, paint or coating can firmly be attached to the surface 15.

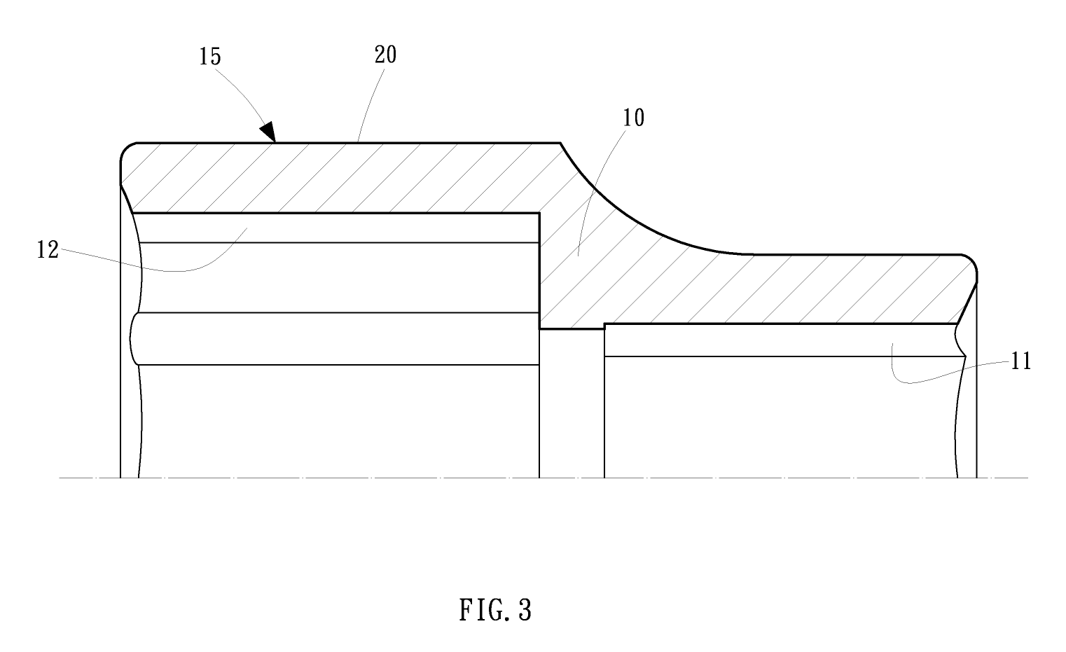

Then, referring to FIG. 3, the socket 10 is subjected to the step of ground-providing to form a ground layer 20 on the surface 15. The step of ground-providing may include the step of black-dying, coating of manganese or zinc phosphate, or electroplating. The ground layer 20 is preferably black for sharp contrast against colors to be provided thereon.

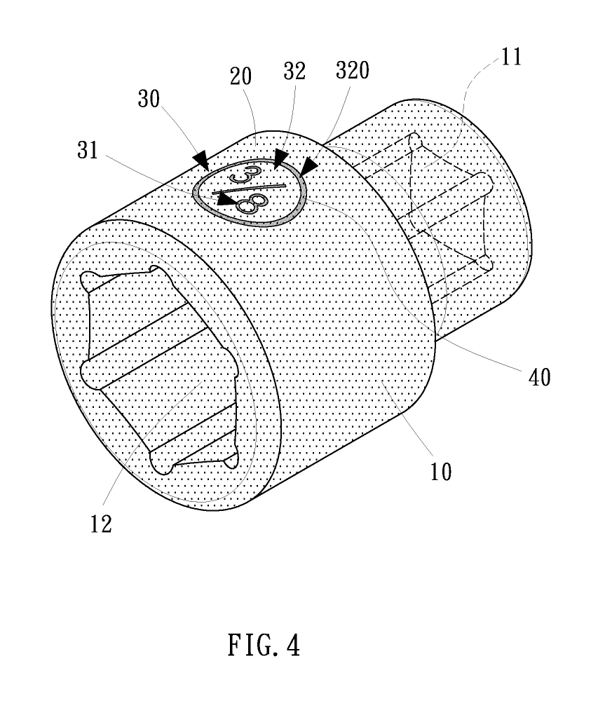

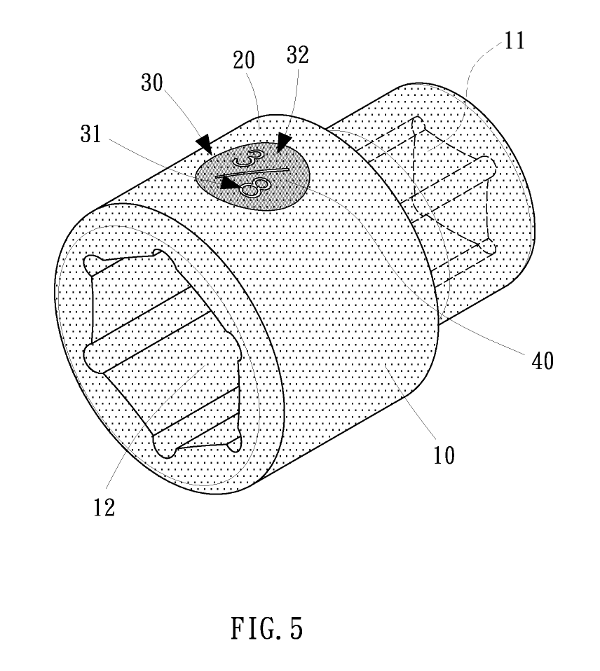

Then, referring to FIGS. 4 and 5, the socket 10 is subjected to the step of printing to provide a paint layer 40 on the ground layer 20. The paint layer 40 may be made of transparent paint for protecting the ground layer 20 provided on the surface 15 of the socket 10 from rust.

The paint layer 40 includes at least one identification unit 30. The identification unit 30 may be used to indicate the size of the socket 10, a pattern, a logo or a trademark. The identification unit 30 includes an identification zone 31 in a predetermined position on the ground layer 20, a background 32 around the identification zone 31, and a borderline 320 around the background 32. The identification zone 31 may include numerals, letters, characters and/or any other proper marks. Some paint is provided in the identification zone 31 while some other paint is provided on the borderline 320. The background 32 is clear of any paint.

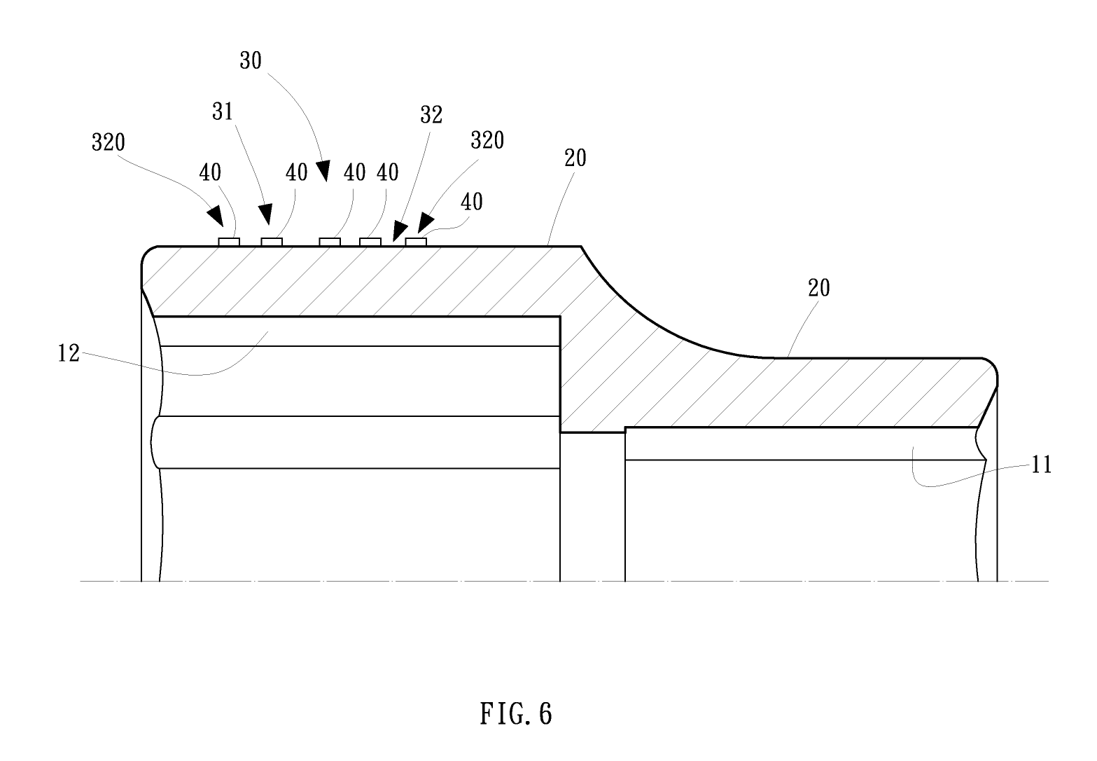

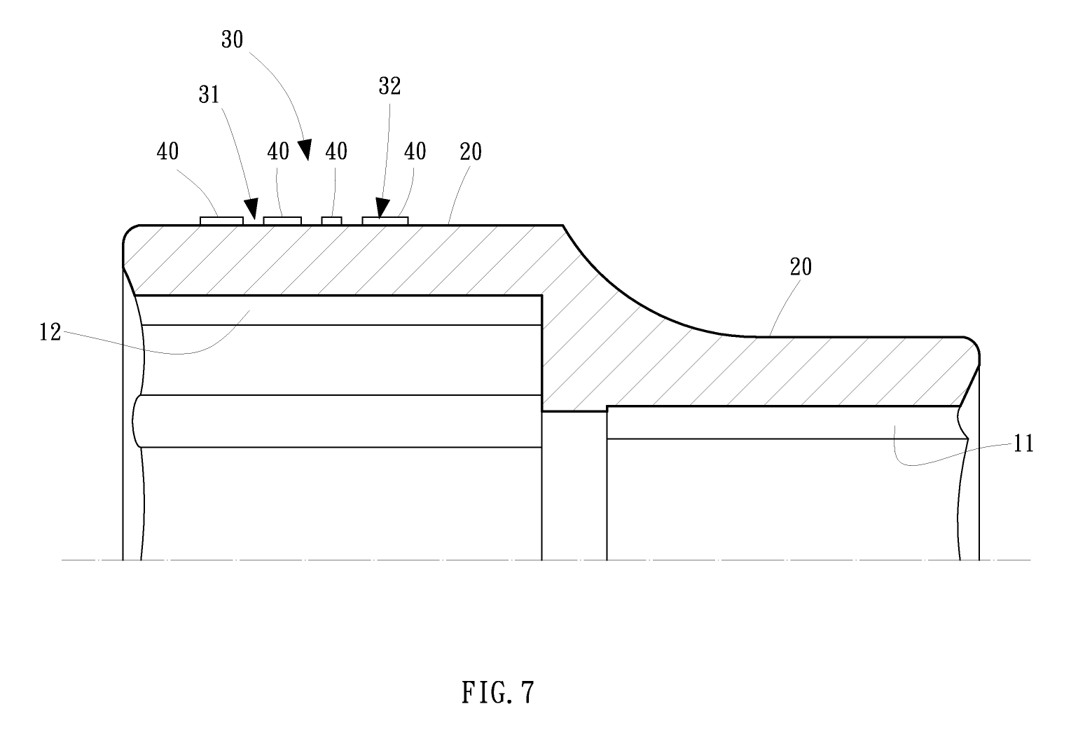

Finally, referring to FIGS. 6 and 7, the socket 10 is subjected to the step of electroplating to provide a coat 50 on the paint layer 40, which includes the identification unit 30. The coat 50 only covers the background 32 of the identification unit 30. The coat 50 is in sharp contrast against the paint layer 40 which is transparent. More particularly, the coat 50 is in sharp contrast against the identification zone 31 and the borderline 320. Thus, the identification of the socket 10 can remain clear for a long period of time.

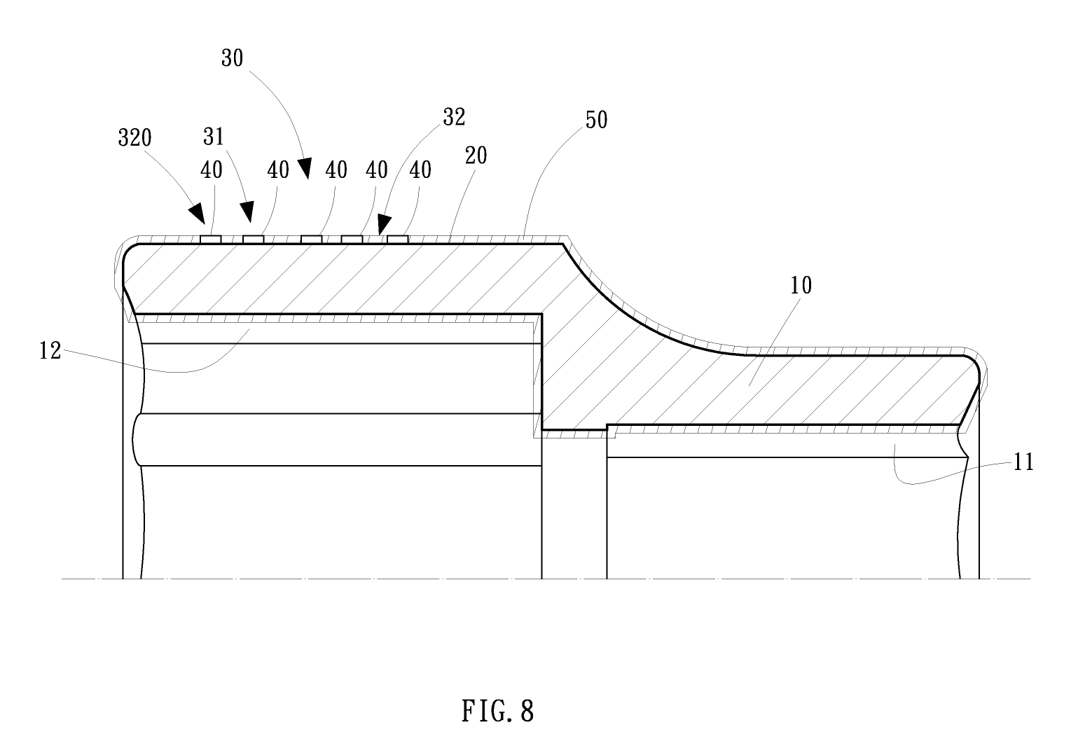

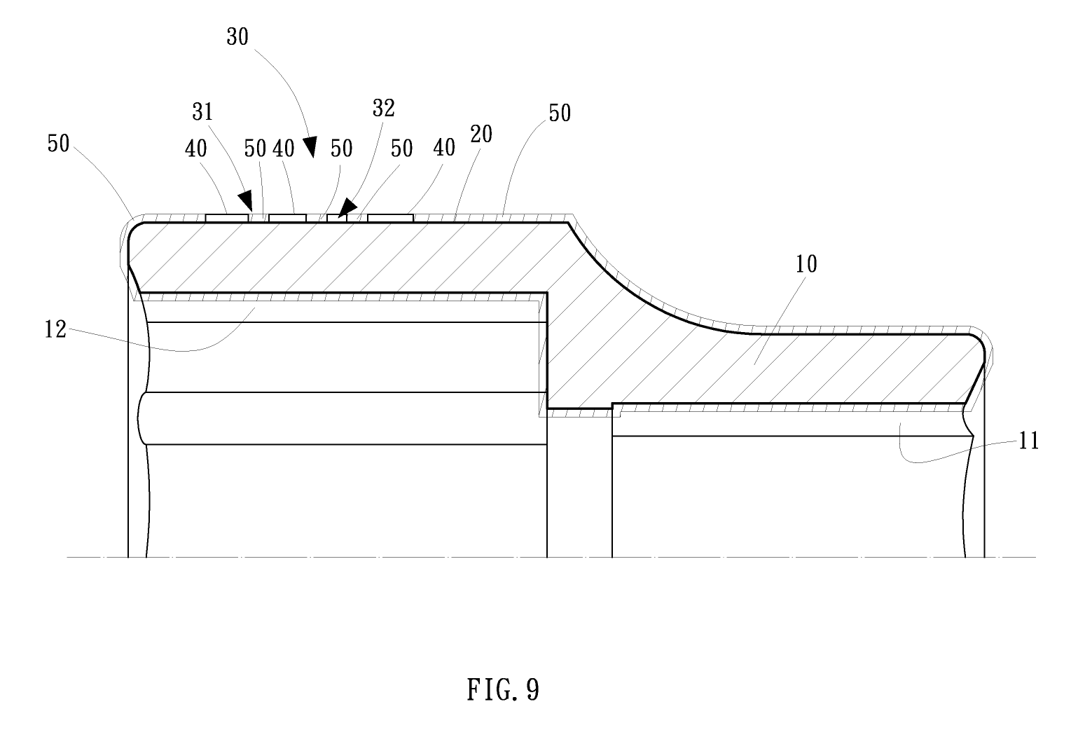

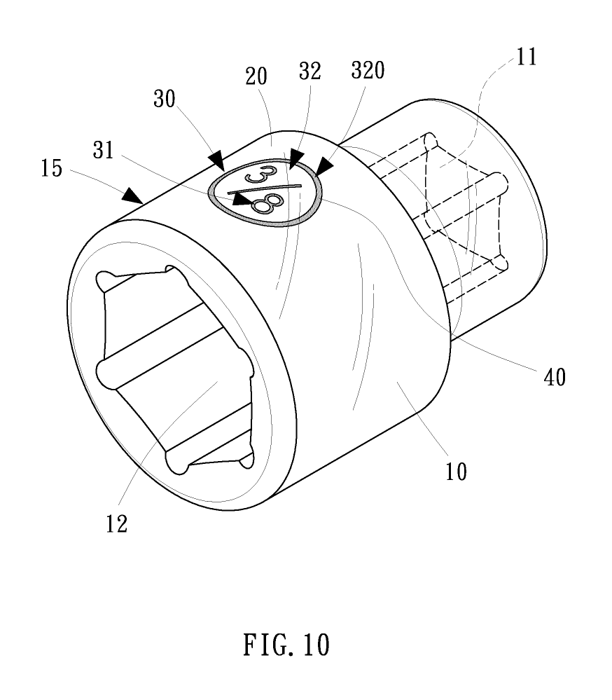

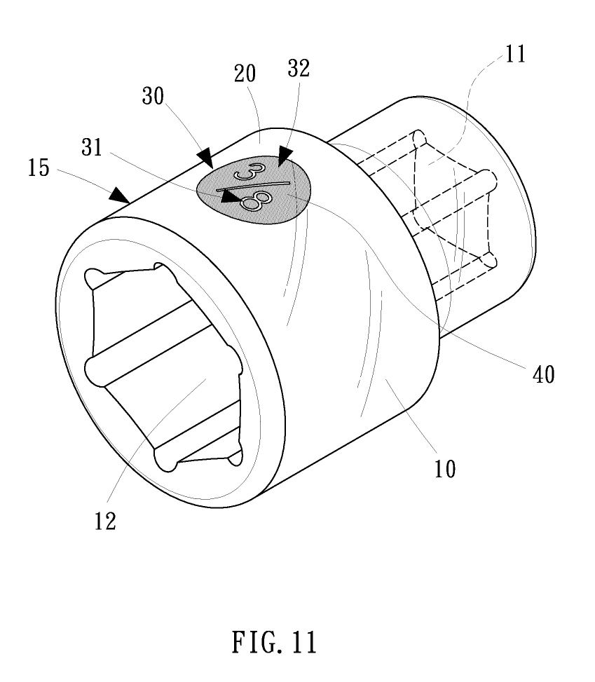

Referring to FIGS. 8 through 11, there is shown a socket 10 marked by a method according to a second embodiment of the present invention. The second embodiment is identical to the first embodiment except including a different step of painting. As shown in FIGS. 8 and 9, the identification zone 31 is clear of paint while the background 32 is provided with paint. There is no borderline around the background 32 of the identification unit 30 made by the method of the second embodiment of the present invention. Referring to FIGS. 10 and 11, the coat 50 covers only the identification zone 31.

The method for marking a socket exhibits at least two advantages.

At first, the surface 15 of the socket 10 is provided with the identification unit 30. The identification unit 30 includes the identification zone 31 and the background 32. The coat 50 covers at least one portion of the ground layer 20 that is exposed to the electroplating via the identification zone 31 or the background 32 in sharp contrast against the paint layer 40 provided on the background 32 or the identification zone 31. Therefore, the identification of the socket is clear and reliable.

Secondly, the paint layer 40 covers the portion of the ground layer 20, which is exposed via the identification zone 31 or the background 32 of the identification unit 30 provided on the surface 15 of the socket 10. The paint layer 40 protects the portion of the ground layer 20 from rust.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A method for marking a tool including the steps of:
providing a tool;
executing heat treatment on the tool for hardening;
providing a ground layer on the tool;
printing the tool to provide a paint layer on the ground layer, wherein the paint layer includes at least one identification unit, wherein the identification unit includes:
at least one identification zone provided with paint;
a background provided around the identification zone and clear of any paint; and
a borderline provided around the background and provided with paint; and
electroplating the tool to provide a coat on portions of the ground layer that are not covered by the identification zone and the borderline, wherein there is sharp contrast of the coat against the paint layer.

2. The method in accordance with claim 1, further including the step of surface processing between the step of heat treatment and the step of providing the ground layer.

3. The method in accordance with claim 2, wherein the step of surface processing includes the step of grinding to clear the tool of burs.

4. The method in accordance with claim 2, wherein the step of surface processing includes the step of shot blast to make the surface of the tool rough for firm attachment of paint to the surface of the tool.

5. The method in accordance with claim 1, wherein the tool is selected from the group consisting of a socket, a wrench, a knife and a screwdriver.

6. The method in accordance with claim 1, wherein the step of providing the ground layer includes a step selected from the group consisting of black-dying, coating of manganese or zinc phosphate, and electroplating.

7. The method in accordance with claim 1, wherein the paint layer is made of transparent paint.

8. A method for marking a tool including the steps of:
providing a tool;
executing heat treatment on the tool for hardening;
providing a ground layer on the tool;
printing the tool to provide a paint layer on the ground layer, wherein the paint layer includes at least one identification unit, wherein the identification unit includes:
at least one identification zone clear of any paint; and
a background provided around the identification zone and provided with paint; and
electroplating the tool to provide a coat on portions of the ground layer that are not covered by the background, wherein there is sharp contrast of the coat against the paint layer.

9. The method in accordance with claim 8, further including the step of surface processing between the step of heat treatment and the step of providing the ground layer.

10. The method in accordance with claim 9, wherein the step of surface processing includes the step of grinding to clear the tool of burs.

11. The method in accordance with claim 9, wherein the step of surface processing includes the step of shot blast to make the surface of the tool rough for firm attachment of paint to the surface of the tool.

12. The method in accordance with claim 8, wherein the tool is selected from the group consisting of a socket, a wrench, a knife and a screwdriver.

13. The method in accordance with claim 8, wherein the step of providing the ground layer includes a step selected from the group consisting of black-dying, coating of manganese or zinc phosphate, and electroplating.

14. The method in accordance with claim 8, wherein the paint layer is made of transparent paint.
